(19) United States
(12) Patent Application Publication
(10) Pub. No.: US 2008/0012964 A1
(43) Pub. Date: Jan. 17, 2008

(54) IMAGE PROCESSING APPARATUS, IMAGE RESTORATION METHOD AND PROGRAM

(76) Inventors: Takanori Miki, Kanagawa (JP); Fuminori Takahashi, Nagano (JP); Hiroaki Komatsu, Nagano (JP)

Correspondence Address: Pamela R. Crocker;Patent Legal Staff,, Eastman Kodak Company, 343 State Street, Rochester, NY, 14650-2201, US

(21) Appl. No.: 11/566,793

(22) Filed: Dec. 5, 2006

(30) Foreign Application Priority Data
Jul. 14, 2006 (JP) 2006-194945

(51) Int. Cl. H04N 5/217

(52) U.S. Cl. 348/241

(57) ABSTRACT

An image processing apparatus is provided which executes image restoration processing by performing a iterative computation on a degradation image. The image processing apparatus is capable of maintaining the quality of a restored image and completing the iterative computation sufficiently quickly. The first image restoration processor creates a first restored image f1 for a degradation image g by calculating an inverse filter H⁻¹ based on Fourier transform H of a deterioration function h, multiplying the inverse filter H⁻¹ and Fourier transform G of the degradation image g, and performing inverse Fourier transform on the result of the multiplication. The second image restoration processor creates a second restored image f2 by a iterative computation using the first restored image f1 and the deterioration function h.

### CROSS REFERENCE TO RELATED APPLICATIONS

This application claims priority to Japanese Patent Application No. 2006-194945 filed on Jul. 14, 2006, which is incorporated herein by reference in its entirety.

### FIELD OF THE INVENTION

The present invention relates to a technique for creating a restored image from a degradation image based on an image restoration algorithm using a deterioration function.

### BACKGROUND OF THE INVENTION

There is conventionally known an image restoration algorithm for restoring a degradation image in the case where an image captured by an image capturing apparatus, such as a digital camera, is degradation by defocusing, blurring, aberration and the like.

As the image restoration algorithm, there is known, for example, a method in which image deterioration caused by blurring at the time of image capturing is expressed by a deterioration function (point spread function (PSF)), and an image without blurring is restored on the basis of the deterioration function.

As the image restoration algorithm using the deterioration function, for example, a Wiener filter, a general inverse filter, a projection filter and the like are known. An image restoration method in which the Wiener filter is used is disclosed in Japanese Patent Laid-Open Publication No. 2004-205802, and an image restoration method in which the general inverse filter is used is disclosed in Japanese Patent Laid-Open Publication No. 2002-288653.

In the case where image restoration is performed by using the image restoration algorithm, and where an original image is f(x, y), a deterioration function is h(x, y), an additive noise n(x, y), and a degradation image is g(x, y), an image deterioration is expressed by the following formula.

g(x,y)=h(x,y)*f(x,y)+n(x,y) (1)

### However, it is difficult to directly obtain f(x, y) from the formula (1).

For this reason, a method in which Fourier transform and a calculation on an image are performed in frequency domain, a method in which iterative computation by a steepest descent method is executed on an image in real domain, and the like, are proposed. Note that the repetition methods include a moment method, a correction moment method, a conjugate gradient method, and the like, in addition to the above described steepest descent method.

However, in the case where diagonalization and calculation are performed based on Fourier transform, for example, pixel interpolation processing, edge processing, and the like, in which non-linear processing is performed by using local information of an image, cannot be performed.

Further, in the image restoration method based on the repetition method, iterative computation needs to be performed a large number of times in order to obtain sufficient image quality.

An advantage of the present invention is to provide an image processing apparatus which performs image restoration processing on a degradation image by a iterative computation, and which is characterized by being capable of maintaining the quality of a restored image and completing the iterative computation sufficiently quickly.

### SUMMARY OF THE INVENTION

According to the present invention, there is provided an image processing apparatus for creating a restored image f for a degradation image g using the captured degradation image g and a deterioration function h determined based on image capture conditions, the image processing apparatus being characterized by comprising: a first image restoration processor for executing image restoration processing by performing Fourier transform and a calculation on the degradation image g in a frequency domain to create a first restored image f1; and a second image restoration processor for executing image restoration processing by performing a iterative computation on the first restored image f1 in a real domain to create a second restored image f2 as the restored image f.

One aspect of the image processing apparatus according to the present invention, is characterized in that the first image restoration processor acquires an inverse filter H⁻¹ based on Fourier transform H of the deterioration function h, and multiplies the inverse filter H⁻¹ and Fourier transform G of the degradation image g, to create the first restored image f1 by performing inverse Fourier transform on the result of the multiplication, and in that the second image restoration processor creates the second restored image f2 from the first restored image f1 and the deterioration function h using a iterative computation.

One aspect of the image processing apparatus according to the present invention is characterized in that the second image restoration processor uses the first restored image f1 as an initial image of the iterative computation.

According to the present invention, there is provided an image processing apparatus for executing image restoration processing by performing a iterative computation on a degradation image, and which is capable of maintaining the quality of a restored image and completing the iterative computation sufficiently quickly.

### BRIEF DESCRIPTION OF THE DRAWINGS

Preferred embodiments of the present invention will be described in detail based on the following figures, wherein:

FIG. 1 is a figure showing a function block for explaining a digital camera according to a present embodiment;

FIG. 2 is a figure showing a function block for explaining an image capturing section according to the present embodiment;

FIG. 3 is a figure showing a function block for explaining an image processor according to the present embodiment;

FIG. 4 is a flow chart showing an image restoration processing procedure performed by a first image restoration processor according to the present embodiment; and

FIG. 5 is a flow chart showing an image restoration processing procedure performed by a second image restoration processor according to the present embodiment.

### DETAILED DESCRIPTION OF THE INVENTION

The best mode for carrying out the present invention (hereinafter referred to as an embodiment) is explained below with reference to the accompanying drawings.

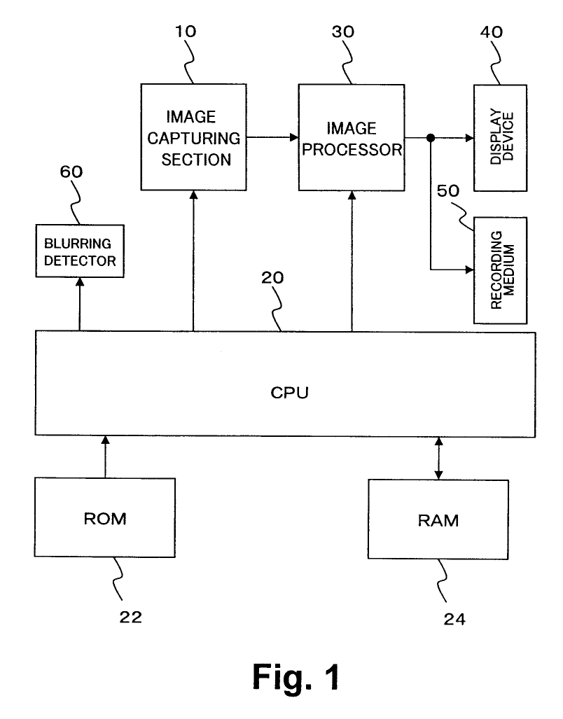

FIG. 1 is a figure showing a function block of a digital camera according to the present embodiment. Note that in the present embodiment, a consumer digital camera is explained as an example of an image processing apparatus. However, the image processing apparatus may be formed as a camera for other applications, such as a camera for monitoring, a camera for television, and an endoscope camera. In addition, the image processing apparatus may also be applied to an apparatus, such as a microscope, binoculars, and further to a diagnostic imaging apparatus for NMR imaging or the like, other than a camera.

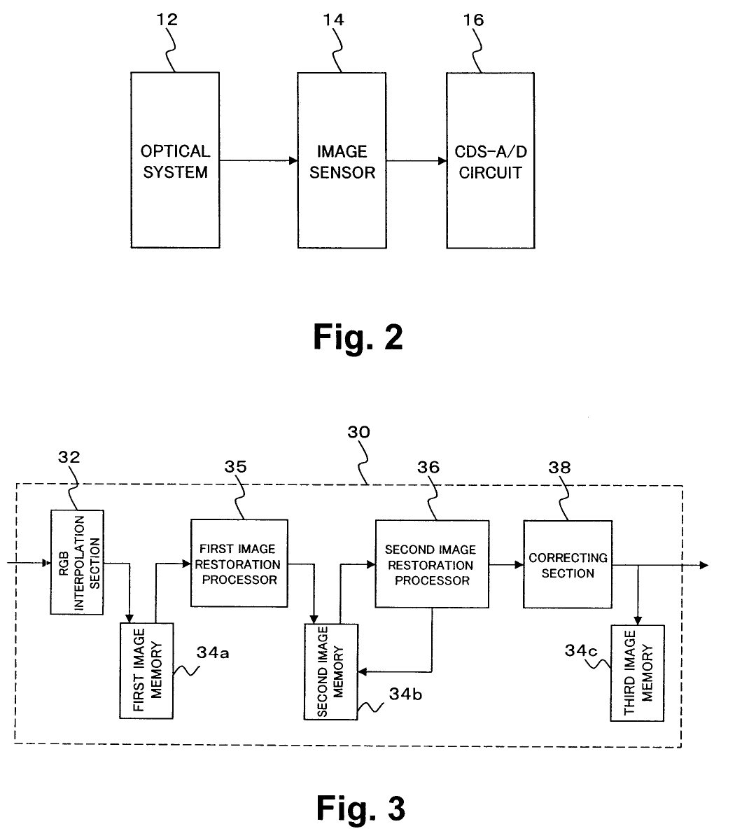

In FIG. 1, an image capturing section 10 receives light from an object under the control of a CPU 20, and outputs RAW data in accordance with the received light. The image capturing section 10 includes an optical system 12, an image sensor 14, and a CDS (Correlated Double Sampling)-A/D (Analog/Digital) circuit 16, as shown in FIG. 2.

The image sensor 14 is provided with a color filter, in which a red filter (R), a green filter (Gr) of R column, a blue filter (B), and a green filter (Gb) of B column are arranged in a Bayer array. From the image sensor 14, an R signal which is a pixel signal of the red filter (R), a Gr signal which is a pixel signal of the green filter (Gr) of R column, a B signal which is a pixel signal of the blue filter (B), and a Gb signal which is a pixel signal of the green filter (Gb) of B column are outputted. The CDS (Correlated Double Sampling)-AD (Analog/Digital) circuit 16 reduces noise of the RAW data outputted from the image sensor 14 by performing correlated double sampling, and converts an analog signal of the RAW data to a digital signal.

The CPU 20 is a central processing unit which controls the whole digital camera. The CPU 20 expands, in a RAM 24, various programs and parameters which are stored in a ROM 22, and performs various kinds of calculation. An image processor 30 performs various kinds of image processing, such as RGB interpolation and white balance, on the RAW data, and outputs image data obtained as the result of the processing. A display device 40 functions as a viewfinder for image capturing by displaying a video image based on the image data. Further, a recording medium 50 records the image data. A blurring detector 60 is provided with two angular velocity sensors which detect angular velocities about the X-axis and Y-axis which are perpendicular direction to the Z-axis serving as an optical axis of the digital camera, and outputs time-sequential displacement angles θₓ and θ_{y} about the X-axis and the Y-axis, these angles being caused by the user's hand movement at the time of image capturing.

Note that in the present embodiment, it is necessary to obtain beforehand a deterioration function h in order to use the function for image restoration processing as described below. Thus, for example, the CPU 20 calculates a displacement trajectory of blurring on the image sensor 14 based on a focal distance of a lens which is presently obtained on the basis of a zoom position, and on the displacement angles θₓ and θ_{y} outputted from the blurring detector 60, and obtains the deterioration function h from the calculated displacement trajectory of blurring on the image sensor 14, so as to store the deterioration function in the RAM 24. Note that the deterioration function h may be obtained by a known method based on information obtained during or prior to image capturing, such as information on defocusing, aberration and optical low pass filter.

FIG. 3 is a figure showing a function block of the image processor 30 in more detail. Here, the image processor 30 includes a first image restoration processor 35 for executing image restoration processing by performing Fourier transform and a calculation in frequency domain on a degradation image, the deterioration of which is caused by blurring, and a second image restoration processor 36 for executing image restoration processing by performing a iterative computation on the degradation image in real domain. In the present embodiment, the second image restoration processor 36 performs image restoration processing on a restored image obtained by the image restoration processing in the first image restoration processor 35.

In FIG. 3, an RGB interpolation section 32 performs pixel interpolation by known pixel interpolation processing on the RAW data to interpolate lacking color components of each pixel constituting the RAW data by referring to color components of peripheral pixels, and temporarily stores the image in a first image memory 34a. Further, a correcting section 38 performs various kinds of correction processing, such as white balance adjustment, color adjustment, y correction, on the image which is subjected to the restoration processing in the first image restoration processor 35 and the second image restoration processor 36. The image outputted from the correcting section 38 is outputted to the display device 40 as a restored image so as to be screen displayed. Alternatively, the image is temporarily stored in a second image memory 34b, and thereafter is compressed into JPEG data or the like, so as to be recorded in the recording medium 50 as image data of a restored image.

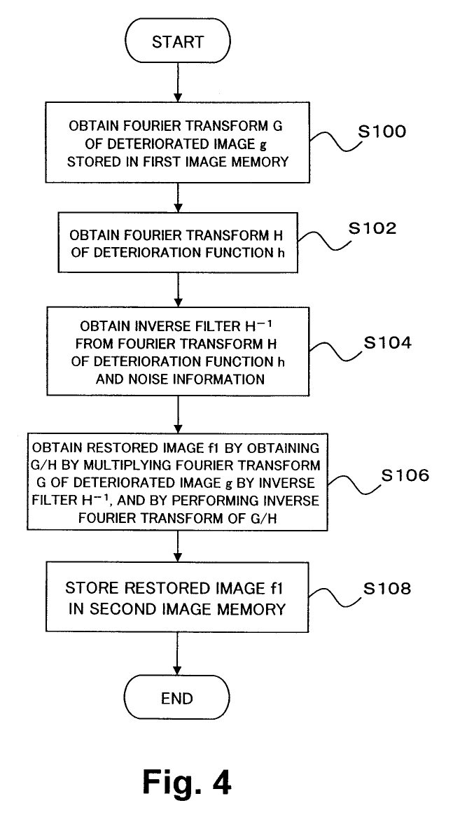

FIG. 4 is a flow chart showing an image restoration processing procedure executed on a degradation image by the first image restoration processor 35.

In FIG. 4, the first image restoration processor 35 first reads a degradation image g from the first image memory 34a, and obtains a Fourier transform G of the degradation image g (S100). Further, the first image restoration processor 35 reads the deterioration function h from the RAM 24, and obtains a Fourier transform H of the deterioration function h (S102). Subsequently, the first image restoration processor 35 obtains an inverse filter H⁻¹ by a known technique using the Fourier transform H of the deterioration function h and noise information registered beforehand in the ROM 22 (S104). Note that when the noise information is ignored, the inverse filter H⁻¹ is expressed by an inverse matrix of H. Note that when the Fourier transform H is irregular, an inverse matrix cannot be obtained, and hence, the inverse filter H⁻¹ is expressed by a Moore-Penrose general inverse matrix. Then, the first image restoration processor 35 multiplies the Fourier transform G of the degradation image g and the inverse filter H⁻¹ to obtain G/H, and applies inverse Fourier transform to G/H to obtain a restored image f1 (S106). The first image restoration processor 35 stores the obtained restored image f1 in the second image memory 34b (S108).

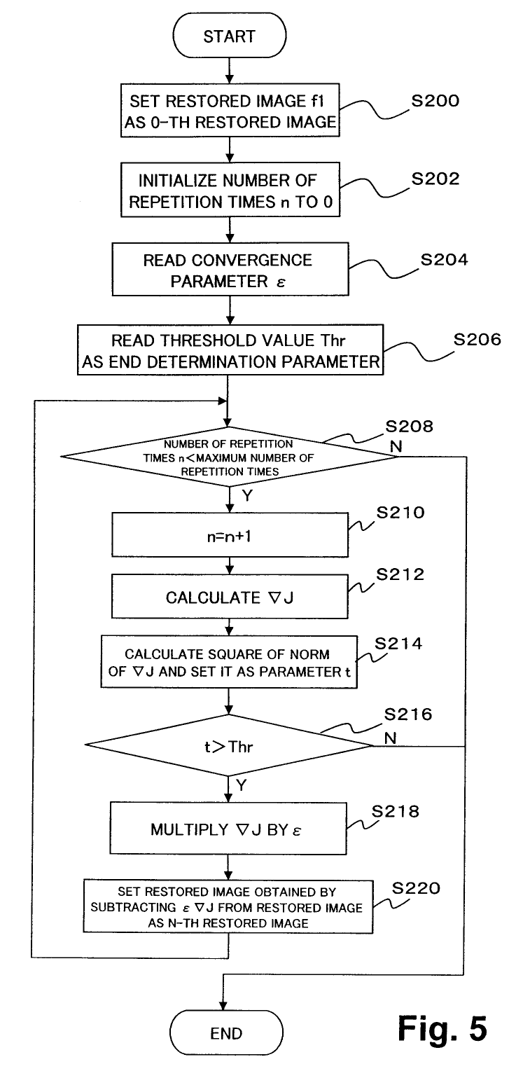

Next, an image restoration processing procedure in the second image restoration processor 36 will be explained with reference to a flow chart shown in FIG. 5. The second image restoration processor 36 performs image restoration processing using an image restoration algorithm based on a steepest descent method which is one of the repetition methods. Here, the image restoration algorithm performed by the second image restoration processor 36 is not limited to the steepest descent method, and other repetition methods, such as a moment method, a correction moment method, and a conjugate gradient method, may also be used.

The present embodiment is characterized in that the second image restoration processor 36 utilizes the restored image f1, which is obtained by the first image restoration processor 35 by performing the image restoration processing on a degradation image, as an initial image at the time when the second image restoration processor 36 starts image restoration processing.

In FIG. 5, the second image restoration processor 36 sets the restored image f1, which is obtained by the first image restoration processor 35 by performing the image restoration processing on a degradation image, as the 0-th restored image (that is, the initial image) in the second image memory 34b (S200). Next, the second image restoration processor 36 initializes a parameter n indicating the number of repetition times to 0 (S202), and reads a predetermined convergence parameter ε from the ROM 22 (S204). Further, the second image restoration processor 36 reads a threshold value Thr as an end determination parameter from the ROM 22 (S206). Next, when the number of repetition times n is smaller than a predetermined maximum number of repetition times (the determination result in step S208 is Yes: “Y”), after incrementing the number of repetition times n (S210), the second image restoration processor 36 calculates ∇J (nabla) (S212), and calculates the square of the norm of ∇J, so as to set the calculation result as a parameter t (S214).

Here, J is an evaluation quantity of a general inverse filter, and is given by the formula: J=∥g(x, y)−h(x, y)*f(x, y)∥², where g(x, y) is a degradation image, f(x, y) is a restored image, and h(x, y) is a deterioration function. The above formula means that the evaluation quantity J can be given as the magnitude of the difference between an image h(x, y)*f(x, y) which is obtained by performing the deterioration function h(x, y) on the restored image f(x, y), and the actual degradation image g(x, y). If the restored image is correctly restored, the formula: h(x, y)*f(x, y)=g(x, y) is theoretically established, and hence, the evaluation quantity is zero. Thus, the smaller evaluation quantity J means that the restored image f(x, y) is restored better. In the steepest descent method, iterative computation is repeated until the magnitude of ∇J which is the gradient of the evaluation quantity J. i.e., the square of the norm of ∇J, becomes equal to or smaller than the threshold value. When the magnitude of ∇J becomes smaller than the threshold value, the iterative computation is completed, and thereby the restored image f(x, y) is obtained.

Now, returning to FIG. 5, the second image restoration processor 36 determines whether or not t exceeds the threshold value Thr (S216). When t exceeds the threshold value Thr, the second image restoration processor 36 determines that the restoration is not sufficiently performed, and multiplies ∇J and the convergence parameter ε (S218). Then, the second image restoration processor 36 creates a new restored image by subtracting ε∇J from the restored image (S220), and repeats the processing of S208 to S220 until t becomes equal to or smaller than the threshold value Thr. When t becomes equal to or smaller than the threshold value Thr (the determination result in step S216 is Yes: “Y”), or when the number of repetition times reaches the maximum number of repetition times even though t is not equal to or smaller than the threshold value Thr (the determination result of step S208 is No: “N”), the second image restoration processor 36 completes the processing.

Thereby, the second image restoration processor 36 eventually obtains a restored image f2. In the present embodiment, the second image restoration processor 36 which performs image restoration processing by a repetition method utilizes the restored image f1, which is obtained by the first image restoration processor 35 by performing the image restoration processing on a degradation image, as an initial image. Therefore, the second image restoration processor 36 applies image restoration processing to the image, the deterioration of which is improved to some extent, thereby enabling the iterative computation to quickly converge in comparison with the case where the image restoration processing is applied to a degradation image obtained by image-capturing as an image which is not subjected to the image restoration processing.

Note that the above described image processor 30 can be realized by installing programs for embodying various kinds of processing such as image restoration processing, in a microcomputer, and by executing the program.

That is, the microcomputer has a CPU, various memories such as ROM, RAM and EEPROM, a communication bus and an interface. The CPU reads the image processing programs, such as an image restoration algorithm stored beforehand in the ROM as firmware, and executes the programs successively. The CPU receives an input of a degradation image from an image sensor, such as CCD (Charge Coupled Devices) and CMOS, via the interface, executes image restoration processing by performing Fourier transform and a calculation on the degradation image in frequency domain, and further executes image restoration processing by performing a iterative computation on the resultant restored image in real domain.

### PARTS LIST

10 image capturing section
12 optical system
14 image sensor
16 CDS (Correlated Double Sampling)-A/D (Analog/Digital) circuit
20 CPU
22 ROM
24 RAM
30 image processor
32 RGB interpolation section
34a first image memory
34b second image memory
35 first image restoration processor
36 second image restoration processor
38 correcting section
40 display device
50 recording medium
60 blurring detector
S100 step
S102 step
S104 step
S106 step
S108 step
S200 step
S202 step
S204 step
S206 step
S208 step
S210 step
S212 step
S214 step
S216 step
S218 step
S220 step

1. An image processing apparatus for creating a restored image f for a degradation image g using the captured degradation image g and a deterioration function h determined based on image capture conditions, comprising:
a first image restoration processor for executing image restoration processing by performing Fourier transform and a calculation on the degradation image g in a frequency domain to create a first restored image f1; and
a second image restoration processor for executing image restoration processing by performing a iterative computation on the first restored image f1 in a real domain to create a second restored image f2 as the restored image f.

2. The image processing apparatus according to claim 1,
wherein the first image restoration processor acquires an inverse filter H⁻¹ based on Fourier transform H of the deterioration function h, and multiplies the inverse filter H⁻¹ and Fourier transform G of the degradation image g, to create the first restored image f1 by performing inverse Fourier transform on the result of the multiplication, and
wherein the second image restoration processor creates the second restored image f2 from the first restored image f1 and the deterioration function h using the iterative computation.

3. The image processing apparatus according to claim 1,
wherein the second image restoration processor uses the first restored image f1 as an initial image of the iterative computation.

4. An image restoration method for creating a restored image f for a degradation image g using the captured degradation image g and a deterioration function h determined based on image capture conditions, comprising:
creating a first restored image f1 by executing image restoration processing by performing Fourier transform and a calculation on the degradation image g in a frequency domain; and
creating a second restored image f2 as the restored image f by executing image restoration processing by performing a iterative computation on the first restored image f1 in areal domain.

5. A program for causing a computer to function as an image processing apparatus for creating a restored image f for a degradation image g using the captured degradation image g and a deterioration function h determined based on image capture conditions, the program:
a first image restoration processor for executing image restoration processing by performing Fourier transform and a calculation on the degradation image g in a frequency domain to create a first restored image f1; and
a second image restoration processor for executing image restoration processing by performing a iterative computation on the first restored image f1 in a real domain to create a second restored image f2 as the restored image f.
